(19) United States
(12) Patent Application Publication
(10) Pub. No.: US 2006/0212807 A1
(43) Pub. Date: Sep. 21, 2006

(54) Information display apparatus

(75) Inventor: Atsushi Narusawa, Hino (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/328,761

(22) Filed: Jan. 10, 2006

(30) Foreign Application Priority Data
Mar. 15, 2005 (JP) 2005-072428

(51) Int. Cl. G06F 15/00

(52) U.S. Cl. 715/526

(57) ABSTRACT

An information display apparatus which displays additional information together with contents to be displayed on a predetermined display element, includes a display section for displaying the contents to be displayed and the additional information in different areas in a format depending on an attribute of the contents to be displayed.

The entire disclosure of Japanese Patent Application No. 2005-072428, filed Mar. 15, 2005, is expressly incorporated by reference herein.

### BACKGROUND OF THE INVENTION

1. Field of the Invention

The present invention relates to an information display apparatus which displays additional information together with the contents to be displayed on a predetermined display element.

2. Description of the Related Art

Conventionally, a technology of this type is, for example, an information display apparatus which displays contents to be displayed by over lapping additional information on a gray scale (displaying a so-called watermark) for avoiding a leak or falsification of the contents to be displayed (refer to JP-A-2004-213128).

Additionally, a display section which can display the above-mentioned contents to be displayed can be a cholesteric liquid crystal or twisted nematic display element, etc. with storing capability.

### SUMMARY

With an apparatus using a display element with storing capability by combining the above-mentioned conventional technologies, contents to be displayed can be displayed with additional information overlapping on gray scale. However, since it is generally difficult to allow a display element with storing capability to express appropriate gray scale, there is the possibility that contents to be displayed and additional information cannot be clearly recognized because they are displayed as overlapping each other.

The present invention has been developed to solve the above-mentioned problems with the conventional technologies, and aims at providing an information display apparatus capable of preventing contents to be displayed and browsing information from being unclearly displayed using a display element having poor expression on gray scale.

To solve the above-mentioned problems the information display apparatus according to the present invention displays additional information together with the contents to be displayed on a predetermined display element, and includes a display section for displaying the contents to be displayed and the additional information in different areas in a format depending on the attribute of the contents to be displayed.

The display section can display the contents to be displayed by a layout having a predetermined free space, and display the additional information in the free space.

Furthermore, the display section can scale down and display the contents to be displayed, and display the additional information in a free space generated by the scaledown.

Additionally, the display section can display the contents to be displayed as is when there is a free space at the same position on each page of the contents to be displayed, and display additional information in a free space at the same position.

The display element can be a display element with storing capability which maintains a display state even after power supply stops.

With the above-mentioned configuration, contents to be displayed and additional information can be prevented from overlapping each other. Therefore, unlike the method of displaying additional information as overlapping contents to be displayed on gray scale (in a watermark format), the contents to be displayed and the additional information can be prevented from being unclearly displayed by a display element having poor expression on gray scale.

Furthermore, the additional information can include the information about current and past users who display the contents to be displayed.

With the above-mentioned configuration, for example, when contents data is communicated among a plurality of users, the communication path can he surveyed.

### BRIEF DESCRIPTION OF DRAWINGS

FIG. 1 is a block. diagram of the internal configuration of the information display apparatus to which the present invention is applied.

FIG. 2 is an explanatory view showing the configuration of user information.

FIGS. 3A to 3C are explanatory views showing the configuration of document data.

FIG. 4 is a flowchart of the fingerprint authenticating process.

FIG. 5 is an explanatory view showing the display state of the display panel of the operation unit.

FIGS. 6A and 6B are flowcharts of the key release process and the browsing information composing process.

FIG. 7 is an explanatory view showing the display state of the display panel of the operation unit.

FIG. 8 is an explanatory view showing the display state of the display panel of the display unit.

FIG. 9 is a flowchart showing the display-with-browsing-information process.

FIGS. 10A to 10C are explanatory views showing the operation of the information display apparatus.

### DESCRIPTION OF THE PREFERRED EMBODIMENTS

An embodiment of the information display apparatus according to the present invention is described below by referring to the attached drawings.

Configuration of Information Display Apparatus

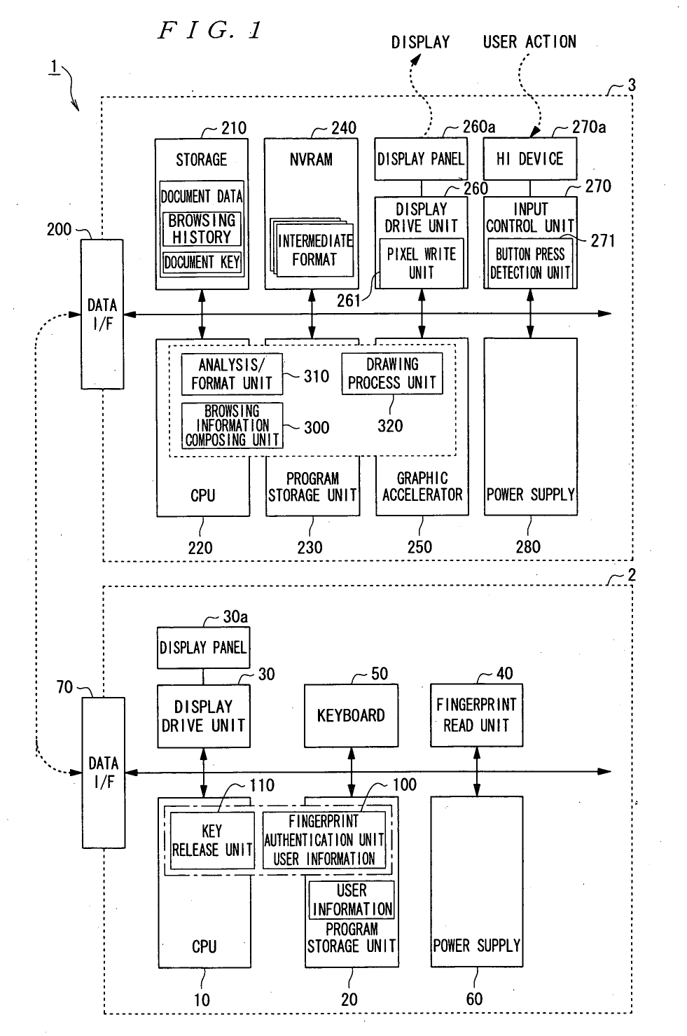

FIG. 1 is a block diagram of the internal configuration of an information display apparatus 1 to which the present invention is applied. The information display apparatus 1 includes an operation unit 2 for performing various operations such as an operation of selecting contents to be displayed, an operation of recognizing a fingerprint, an operation of inputting a password, etc. as shown in FIG. 1, and a display unit 3 for displaying the selected contents. Configuration of Operation Unit

The operation unit 2 includes a CPU (central processing unit) 10, a program storage unit 20, a display drive unit 30, a fingerprint read unit 40, a keyboard 50, a data I/F (interface) 70, and a power supply 60.

The CPU 10 reads a program about various processes stored in the program storage unit 20 and data about the program and executes it according to the various directive information input from the fingerprint read unit 40 and the keyboard 50, and controls the entire operation unit 2. Then, the CPU 10 stores the process results of the executed various processes in the program storage unit 20, and outputs the drawing data for display (drawing) of the process results to the display drive unit 30.

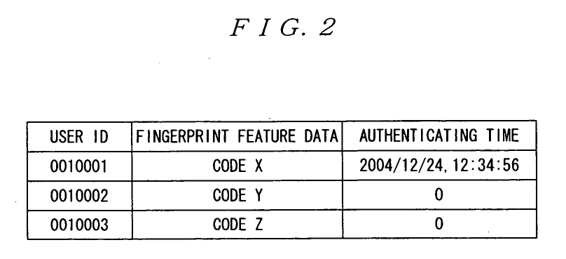

The program storage unit 20 is configured by non-volatile memory. The program storage unit 20 stores various programs for control of each unit of the display unit 3 and data (for example, information about a user (hereinafter also referred to as “user information”) permitted to browse the contents by the information display apparatus 1). The user information is configured by, as shown in FIG. 2, an ID number (user ID) set for a user, data indicating the feature of the fingerprint of a user (fingerprint feature data), and the date and time when the operation unit 2 authenticates the user (authenticating time).

The display drive unit 30 directly drives a display panel 30a, and allows the drawing data (various process results) output by the CPU 10 to be displayed (drawn) on .a display panel 30a.

The fingerprint read unit 40 reads the fingerprint pattern of a finger when a user traces an object by a finger, and outputs the information about the read fingerprint pattern to the CPU 10.

When various keys such as a numeric key, a character key, etc. are pressed, the keyboard 50 outputs the information about the operated key to the CPU 10.

The data I/F 70 is an interface for communicating data with the display unit 3.

The power supply 60 is configured by a primary battery or a secondary battery. The power supply 60 supplies power for appropriate operation of each unit to the entire operation unit 2.

Functional Units of Operation Unit

A fingerprint authentication unit 100 and a key release unit 110 are functional units realized by the CPU 10.

The fingerprint authentication unit 100 performs a fingerprint authenticating process when a contents display request is issued. When the fingerprint authenticating process is performed, the unit first reads the information about a fingerprint pattern from the fingerprint read unit 40, and detects the fingerprint feature data matching the fingerprint pattern from the user information. Then, the unit detects the user information corresponding to the detected fingerprint feature data, and sets the authenticating time about the user ID (authenticates the user).

When the authenticating time is set in the fingerprint authenticating process, the key release unit 110 performs a key release process. When the key release process is performed, the unit receives from the display unit 3 the password (hereinafter also referred to as a “document key”) set in the contents specified in the display request (hereinafter also referred to as “contents to be displayed”), and determines whether or not the document key matches a user input password. When they match each other, a matching notification is transmitted to the display unit 3. When they do not match, it transmits a nonmatching notification to the display unit 3.

Configuration of Display Unit

On the other hand, as shown in FIG. 1, the display unit 3 includes a data I/F 200, a storage 210, a program storage unit 230, NVRAM 240, a graphic accelerator 250, a display drive unit 260, a display panel 260a, an input control unit 270, an HI (human interface) device 270a, and a power supply 280.

The data I/F 200 is to communicate data between the operation unit 2 and the display unit 3, and is configured by, for example, a communication interface, etc.

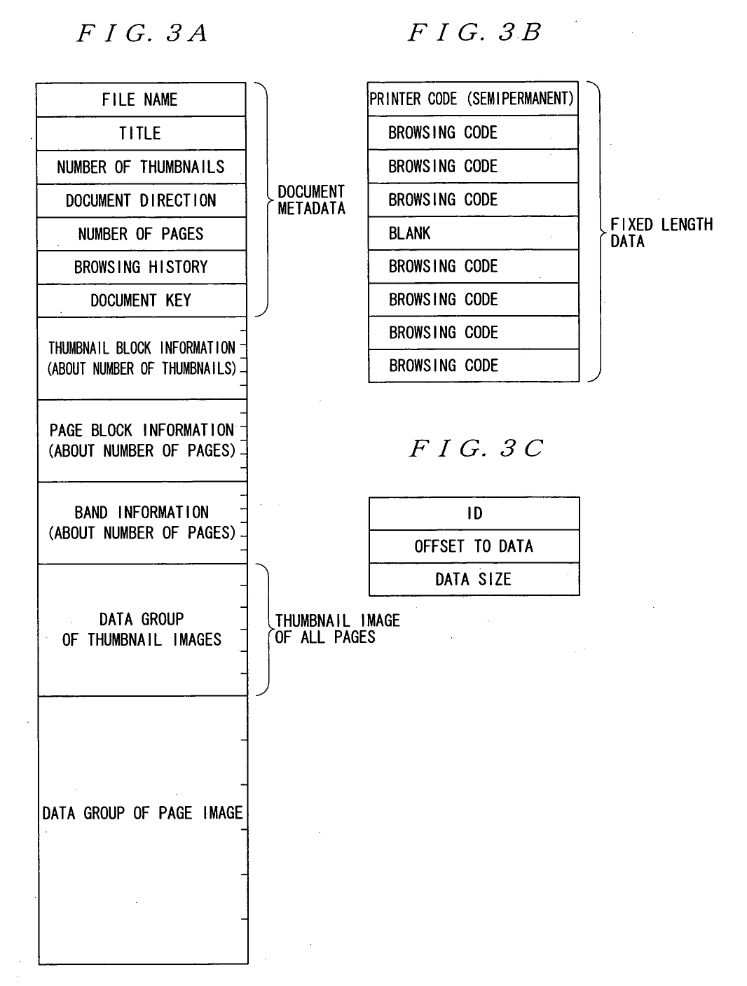

The storage 210 is configured by non-volatile memory. The storage 210 stores an information group about contents to be displayed (hereinafter also referred to as “document data”). The document data is configured by, as shown in FIG. 3A, document metadata (file name, title, number of thumbnails, document direction, page number, browser history), thumbnail block information, page block information, band information, thumbnail image data, and page image data. The browsing information is configured by the information about the generator of a document code (printer code), and the information about a user who displays the contents (browser code) in this order as shown in FIG. 3B. The thumbnail block information is configured by an ID, an offset to data, and a data size as shown in FIG. 3C.

The CPU 220 reads and executes a program relating to various processes and the data relating to the programs stored in the program storage unit 230 according to various kinds of directive information input from the input control unit 270, and controls the entire display unit 3. The CPU 220 performs various processes to draw and display on the display panel 260a the contents to be displayed and stored in the storage 210, and stores the process result in the NVRAM 240.

The program storage unit 230 is configured by non-volatile memory. The program storage unit 230 stores various programs to control each unit of the display unit 3.

The NVRAM 240 is configured by non-volatile memory (memory which maintains stored memory even after power-off) such as FRAM (ferroelectric random access memory), MRAM (magnetoresistive random access memory), nvSRAM (non-volatile static random access memory), etc. When the CPU 220 performs various processes, the NVRAM 240 stores the process results.

The graphic accelerator 250 is hardware for performing a drawing process on an image to be displayed on the display panel 260a according to an instruction from the CPU 220. Practically, the graphic accelerator 250 develops data of a page image input by the CPU 220. The graphic accelerator 250 outputs to the display drive unit 260 the image data for drawing graphics obtained in the drawing process on the display panel 260a.

The display drive unit 260 directly controls the display panel 260a, and draws an image of the image data input from the graphic accelerator 250 on the display panel 260a. Practically, the display drive unit 260 is provided with a pixel write unit 261 to which the graphic accelerator 250 inputs image data. The display drive unit 260 refers to the image data input to the pixel write unit 261, and drives an X driver and a Y driver of the display panel 260a, thereby drawing an image of the input image data on the display panel 260a.

The display panel 260a is configured by a display device with storing capability (display device which maintains a display screen even after power-off) of high pixel density (multiple pixels) of an A4 size image. The display panel 260a displays pixel data on a predetermined pixel according to the control of the display drive unit 260. The display panel 260a can be, for example, an electrophoresis display, a cholesteric liquid crystal display, an electrodeposition display, etc.

The input control unit 270 has the function of an interface for controlling a signal input from the HI device 270a to the CPU 220. The input control unit 270 performs a predetermined process according to the information input from the HI device 270a, and outputs the process result to the CPU 220.

The HI device 270a is configured by an input device such as a cross-shaped direction button indicating the up, down, left, and right directions, a button-shaped determination button which can be pressed, etc. The HI device 270a can accept a directive input from a user to the display unit 3.

The power supply 280 is configured by a primary battery or a secondary battery. The power supply 280 supplies electric power for appropriately operating each unit in the entire display unit 3.

Functional Units of Display Unit

A browsing information composing unit 300, an analysis/format unit 310, and a drawing process unit 320 are functional units realized by the CPU 220 and the graphic accelerator 250.

When an authenticating time is set in the fingerprint authenticating process, the browsing information composing unit 300 performs a browsing information composing process. Then the browsing information composing process is performed, the unit transmits a document key of the contents to be displayed to the display unit 3, and determines whether or not the operation unit 2 has transmitted a matching notification. If the operation unit 2 has transmitted the matching notification, a display-with-browsing-information process is performed. If a nonmatching notification is transmitted, a message notifying that the contents cannot be displayed is displayed.

The browsing information composing unit 300 sets a style based on the attribute of a page image of document data of the contents to be displayed, and the analysis/format unit 310 performs a display-with-browsing-information process of adding browsing history represented by a title contained in the document data of the contents to be displayed and a two-dimensional bar code and an information group including the user ID received in step S302 (hereinafter referred to also as “browsing information”) to the drawing component of the document data for which the style has been set.

The analysis/format unit 310 arranges the data of the page image contained in the document data stored in the storage 210 based on the style set by the browsing information composing unit 300 for each display unit such as a page, etc., and develops the data to the drawing component of the specified style

The analysis/format unit 310 also develops the entire document data or the first portion to be displayed to a drawing component in advance to display the contents to be displayed on the display panel 260a, and allows the NVRAM 240 to store the developed document data, user information and browsing history. The format of the image data generated by the analysis/format unit 310 is also referred to as an “intermediate format”.

The drawing process unit drawing process unit 320 processes the data in the intermediate format to be displayed, and generates a bit map depending on the number of pixels of the display panel 260a. That is, the drawing process unit 320 performs a process of linearly analyzing a graphic form such as a continuous straight line, a Bezier curve, a polygon, etc. (process of analyzing to a predetermined vector sum), and performs a series of processes of expressing in a bit map a vector image contained in the data in an intermediate format such as calculating a pixel position as a passage point of a straight line, an arc, etc. Then, the drawing process unit 320 outputs the mapped data to the display drive unit 30.

Operation of Information Display Apparatus

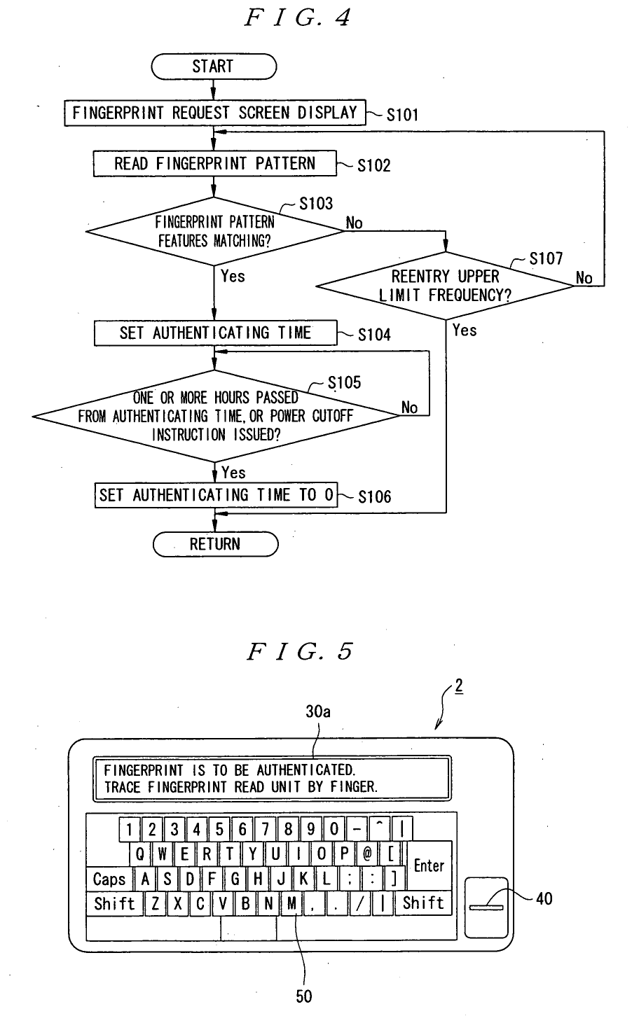

The fingerprint authenticating process executed by the fingerprint authentication unit 100 (CPU 10) of the operation unit 2 according to the flowchart shown in FIG. 4. The fingerprint authenticating process is a process executed in response to a request to display contents from a user, and controls the display drive unit 30 in step S101 as shown in FIG. 4, and a fingerprint request screen display process of displaying on the display panel 30a a message prompting a user to perform an operation of tracing the fingerprint read unit 40 by a finger (for example, “The fingerprint is to be authenticated. Trace the fingerprint read unit by a finger.”) is performed as shown in FIG. 5.

In step S102, the fingerprint read unit 40 reads the information about the fingerprint pattern information.

Then, in step S103, it is determined whether or not the feature of the fingerprint pattern matches the feature of the registered fingerprint pattern of the user based on the information about the fingerprint pattern read in step S102 and the fingerprint feature data about the user information stored in the program storage unit 20. When they match (YES), control is passed to step S104. When they do not match (NO), control is passed to step S107.

In step S104, the user ID corresponding to the fingerprint feature data for which it is determined in step S103 that the features match with the fingerprint pattern is detected, and the current time is set as the authenticating time for the user ID.

Then, control is passed to step S105, and it is determined whether or not one or more hours have passed from the authenticating time set in step S104 or a power cutoff instruction has been issued by a user. If one or more hours have passed from the authenticating time set in step S104 or a power cutoff instruction has been issued (YES), then control is passed to step S106. Otherwise (NO), the determination is repeatedly performed.

In the above-mentioned step S106, the authenticating time of the user information stored in the program storage unit 20 is first set to “0”, thereby terminating the arithmetic process.

On the other hand, in step S107, it is determined whether or not the frequency of performing the process in step S102 after starting the arithmetic process is higher than the threshold (reentry upper limit frequency). If the frequency is higher than the reentry upper limit frequency (YES), the arithmetic process is terminated. If it is equal to or less than the reentry upper limit frequency (NO), control is passed to step S107.

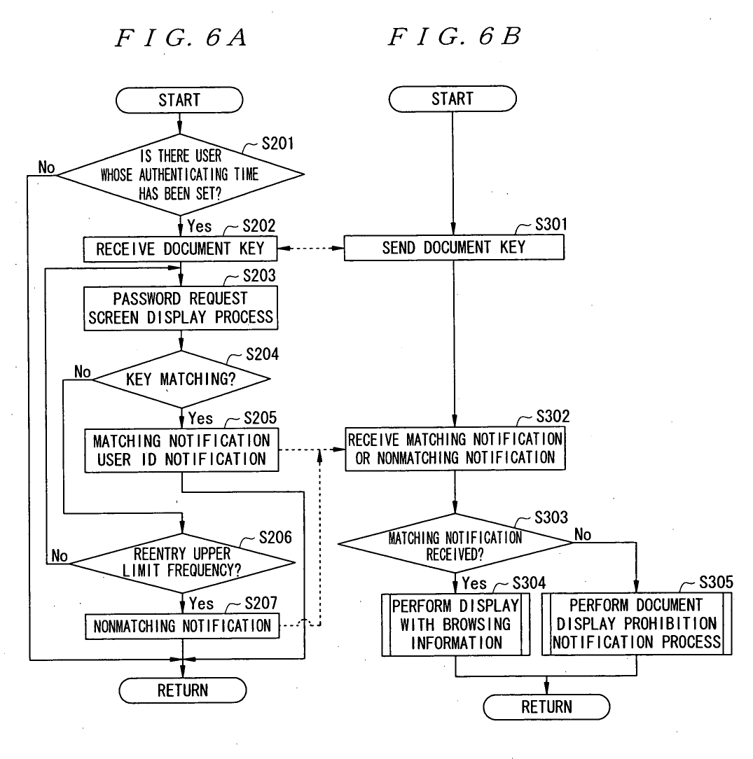

The key release process performed by the key release unit 110 (CPU 10) of the operation unit 2 is explained below by referring to the flowchart shown in FIG. 6A. The key release process is performed if the authenticating time is set in the fingerprint authenticating process. As shown in FIG. 6A, in step S201, it is determined whether or not there is a user whose authenticating time is set in the user information. If there is the user (YES), control is passed to step S202. If there is no corresponding user (NO), then the arithmetic process is terminated.

In step S202, a request signal for request to transmit a document key of contents to be displayed is transmitted to the display unit 3, and the document key output by the display unit 3 is received.

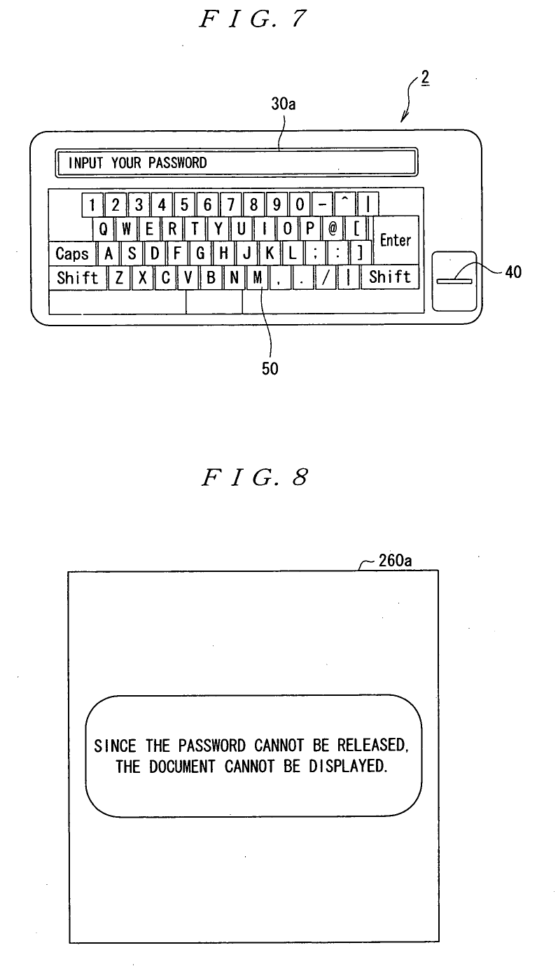

Then, control is passed to step S203, to plurality of the password request screen display process of controlling the display drive unit 30 to display on the display panel 30a the message to prompt a user to input a password (for example, “Input your password.”) using the keyboard 50 as shown in FIG. 7.

Then, control is passed to step S204 to determine whether or not the document key received in step S202 matches the password input through the keyboard 50. If they match (YES), control is passed to step S205. If they do not match (NO), then control is passed to step S206.

In step S205, the matching notification notifying that the document key received in step S202 matches the password input through the keyboard 50, and the user ID corresponding to the authenticating time set in the fingerprint authenticating process are transmitted to the display unit 3, and then the arithmetic process is terminated.

On the other hand, it is determined in step S206 whether or not the frequency of performing the process in step S203 after starting the arithmetic process is higher than the threshold (reentry upper limit frequency). If it is higher than the reentry upper limit frequency (YES), then control is passed to S207. If it is equal to or lower than the reentry upper limit frequency (NO), then control is passed to step S203.

In the above-mentioned step S207, after transmitting to the display unit 3 a nonmatching notification notifying that the document key received in step S202 does not match the password input through the keyboard 50, the arithmetic process terminates.

Then, the browsing information composing process performed by the browsing information composing unit 300 of the display unit 3 and the analysis/format unit 310 (CPU 220) is explained according to the flowchart in FIG. 6B. The browsing information composing process is performed when the authenticating time is set in the fingerprint authenticating process. When the operation unit 2 outputs a request signal to the display unit 3 in step S301 as shown in FIG. 6B, the document key of contents to be displayed is transmitted to the operation unit 2, and control is passed to step S302.

In step S302, after receiving a matching notification or a nonmatching notification transmitted from the operation unit 2, control is passed to step S303

In step S303, it is determined whether or not a matching notification has been received in step S302. When a matching notification is received (YES), control is passed to step S304. When a nonmatching notification is received (NO), control is passed to S305.

In step S304, after the display-with-browsing-information process is performed, the arithmetic process terminates.

In step S305, as shown in FIG. 8, after performing the document display prohibition notification process of displaying on the display panel 30a a message notifying that the contents to be displayed cannot be displayed (for example, “Since the password cannot be reset, the document cannot be displayed.”), the arithmetic process terminates.

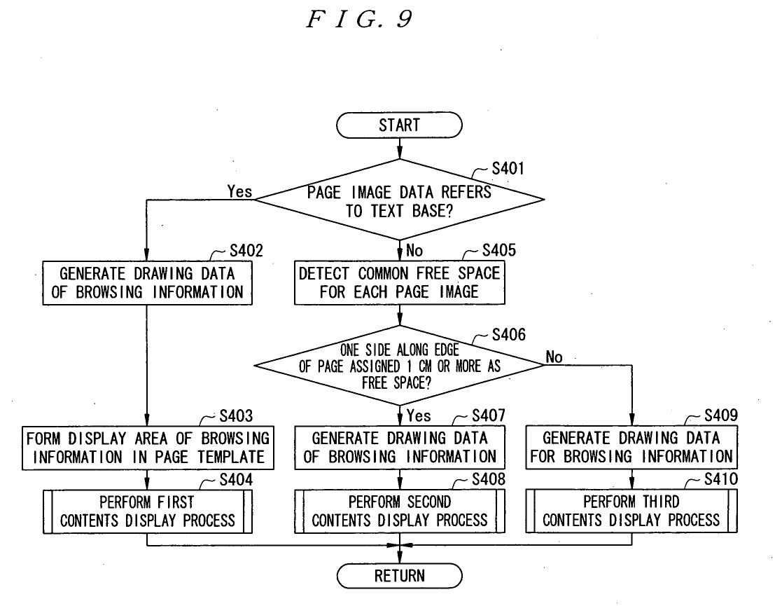

The display-with-browsing-information process performed in step S304 of the browsing information composing process is described below according to the flowchart shown in FIG. 9. In the display-with-browsing-information process, it is determined in step S401 shown in FIG. 9 whether or not the format of the data of the page image contained in the document data of contents to be displayed permits a page layout to be set. Practically, it is determined whether or not the page image data includes text data (text base). If it refers to a text base (YES), control is passed to step S402. If it does not refer to a text base (NO), control is passed to step S405.

In step S402, the drawing data of browsing information is generated in a predetermined size.

Then, in step S403, a free space is allocated at the lower right corner of a page template where a page layout for display of page image data of contents to be displayed to display the drawing data generated in step S402.

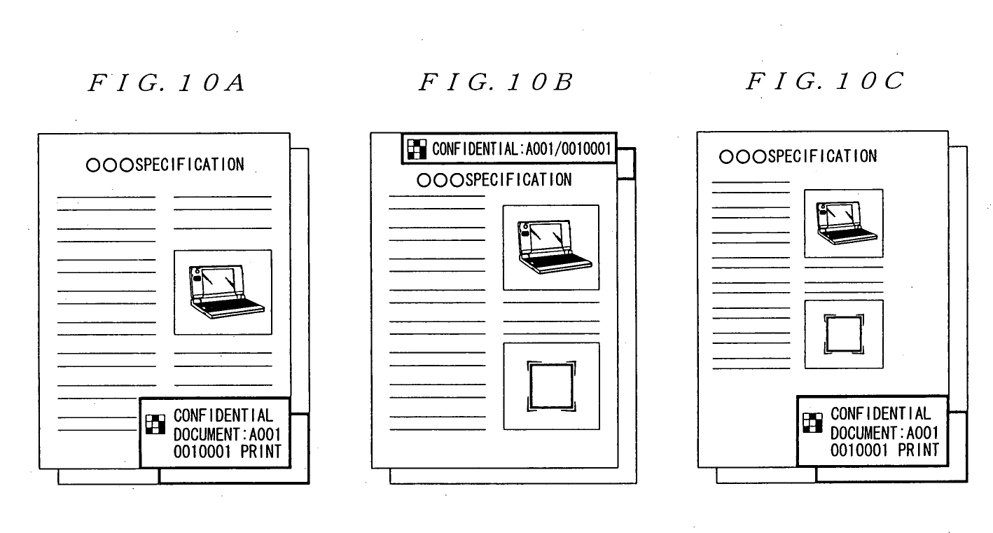

Then, in step S404, first based on the page template where a free space is formed in step S403, the layout of the data of the page image of the contents to be displayed is set. Then, as shown in FIG. 10A, the data of the page image whose layout is set is displayed on the display panel 260a, and the drawing data generated in step S402 is displayed in the free space provided in step S403 in the first contents display process, thereby terminating the arithmetic process.

On the other hand, in step S405, a free space formed at the same position is detected from the data of the page image of each page contained in the document data of the contents to be displayed.

Next, in step S406, it is determined whether or not there is a rectangular free space which has each side of more than 1 cm and formed along the edge of each page in the free space detected in step S405. If there is the rectangular free space (YES), control is passed to step S407. If there is no such free space (NO), control is passed to step S409.

In step S407, drawing data of the browsing information to be displayed in the free space for which it is determined YES in step S406 is generated.

In step S408, as shown in FIG. 10B, the data of the page image of the contents to be displayed is displayed as is on the display panel 260a, and the drawing data generated in step S407 in the free space for which it is determined YES in step S406 is displayed in the second contents display process, thereby terminating the arithmetic process.

On the other hand, in step S409, drawing data of the browsing information is generated in a predetermined size.

Then, in step S410, as shown in FIG. 10C, the drawing data generated in step S409 is displayed at the lower right corner on the display panel 260a, and simultaneously the data of the page image of the contents to be displayed is scaled down and displayed at the upper left corner on the display panel 260a in such a way that these displayed data do not overlap each other in the third contents display process, thereby terminating the arithmetic process.

Practical Operation of Information Display Apparatus

The operation of the information display apparatus 1 according to the present embodiment is described below by referring to a practical example.

First, assuming that the operation of a user displaying contents is performed on the operation unit 2. Then, the fingerprint authentication unit 100 (CPU 10) of the operation unit 2 performs the fingerprint authenticating process, and the fingerprint request screen display process is performed in step S101 as shown in FIG. 4. Then, the display drive unit 30 displays the message “The fingerprint is to be authenticated. Trace the fingerprint read unit by the finger.” on the display panel 30a as shown in FIG. 5.

At the message, the user traces the fingerprint read unit 40 by the finger. Then, the fingerprint read unit 40 reads the fingerprint pattern of the finger which has traced the unit. In step S102, when the information about the read fingerprint pattern is read, and the user ID refers to a user of “0010001”, the determination in step S103 is “YES”, and the current time is set as the authenticating time of the user ID in step S104.

Then, the key release unit 110 (CPU 10) of the operation unit 2 performs the key release process, the determination in step S201 is “YES” as shown in FIG. 6A, and the request signal requesting the transmission of a document key is transmitted to the display unit 3 in step S202.

Furthermore, the browsing information composing unit 300 (CPU 220) of the display unit 3 receives a request signal transmitted from the operation unit 2 in step S201 as shown in FIG. 6B, and a key of the document to be displayed is transmitted to the operation unit 2.

Then, in the key release process by the operation unit 2, the document key transmitted from the display unit 3 is received in step S202, and the password request screen display process is performed in step S203. The display drive unit 30 displays the message “Enter your password.” on the display panel 30a as shown in FIG. 7.

At the message, the user operates the keyboard 50 and inputs an appropriate password. Then, the determination in step S204 is “YES”, and a matching notification notifying that the received document key and the password input through the keyboard 50 match, and the user ID corresponding to the authenticating time are transmitted to the display unit 3 in step S205.

Then, in the browsing information composing process by the display unit 3, a matching notification transmitted from the operation unit 2 is received in step S302, the determination in step S303 is “YES”, and the display-with-browsing-information process is performed in step S304 as shown in FIG. 9.

Assuming that the page image data contained in the document data of the contents to be displayed includes text data, the determination in step S401 is “YES”, and the drawing data of the browsing information including the title contained in the document data of the contents to be displayed, browsing information, and the received user ID are generated in step S402. Then, in step S403, a free space for display of the drawing data of the browsing information is provided at the lower right corner of a page template, and the first contents display process is performed in step S404. The NVRAM 240, the graphic accelerator 250, and the display drive unit 260 sets the layout of the data of the page image of the contents to be displayed is set based on the page template in which the free space is formed. Then, as shown in FIG. 10A, the data of the page image for which the layout is set is displayed on the display panel 260a, and the drawing data of the browsing information is displayed in the provided free space.

On the other hand, assuming that the page image data contained in the document data of the contents to be displayed does not include text data. Then, the determination in step S401 is “NO”, a free space formed at the same position is detected in step S405 from the page image data of each page contained in the document data of the contents to be displayed. Also assume that there is a rectangular free space which has each side of 1 cm or more and is formed along the edge of each page in the detected free space. Then, the determination in step S406 is “YES”, the drawing data of the browsing information to be displayed in the free space is generated in step S407, and the second contents display process is performed in step S408. Next, the NVRAM 240, the graphic accelerator 250, and the display drive unit 260 displays as is the date of the page image of the contents to be displayed on the display panel 260a and the drawing data of the browsing information is displayed in the free space as shown in FIG. 10B.

Assume that there is no rectangular free space which has each side of 1 cm of more and is formed along the edge of each page in the free space detected in step S405. Then, the determination in step S406 is “NO”, the drawing data of the browsing information is generated in a predetermined size in step S409, and the third contents display process is performed in step S410. The NVRAM 240, the graphic accelerator 250, and the display drive unit 260 display the drawing data of the browsing information at the lower right corner of the display panel 260a, and simultaneously scale down and display on the display panel 260a the data of the page image of the contents to be displayed in such a way that these data do not overlap each other as shown in FIG. 10C.

As described above, in the information display apparatus 1 according to the present embodiment, contents to be displayed and browsing information are displayed in different areas in the format depending on the attribute of contents to be displayed. Therefore, contents to be displayed and browsing information can be prevented from overlapping each other. Therefore, unlike the method of displaying browsing information as overlapping contents to be displayed on gray scale (in a watermark format), the contents to be displayed and the browsing information can be prevented from being unclearly displayed by a display element having poor expression on gray scale.

Furthermore, the browsing information can include the information about current and past users (browsing information) who display the contents to be displayed. Therefore, for example, when contents data is communicated among a plurality of users, the communication path can be surveyed.

As described above, steps S401 to S410 shown in FIG. 9 configure the display section described in the scope of the claims for the patent.

The information display apparatus according to the present invention is not limited to the applications of the above-mentioned embodiments, and can be appropriately variable within the scope of the gist of the present invention.

In the embodiments above, contents to be displayed are displayed on the display panel 260a, but the method for outputting them is not limited to the application. For example, the displayed contents to be displayed can be printed.

What is claimed is:

1. An information display apparatus which displays additional information together with contents to be displayed on a predetermined display element, comprising
a display section for displaying the contents to be displayed and the additional information in different areas in a format depending on an attribute of the contents to be displayed.

2. The information display apparatus according to claim 1, wherein
the display section displays the contents to be displayed by a layout having a predetermined free space, and displays the additional information in the free space.

3. The information display apparatus according to claim 1, wherein
the display section scales down and displays the contents to be displayed, and displays the additional information in a free space generated by the scaledown.

4. The information display apparatus according to claim 1, wherein
the display section displays the contents to be displayed as is when there is a free space at the same position on each page of the contents to be displayed, and displays additional information in a free space at the same position.

5. The information display apparatus according to claim 1, wherein
the additional information includes information about current and past users who display the contents to be displayed.

6. The information display apparatus according to claim 1, wherein
the display element is a display element with storing capability which maintains a display state even after power supply stops.
